(19) United States
(12) Patent Application Publication
(10) Pub. No.: US 2008/0233384 A1
(43) Pub. Date: Sep. 25, 2008

(54) Method for Forming Syntactic Foams

(75) Inventor: Ho Sung Kim, New South Wales (AU)

Correspondence Address: FACTOR & LAKE, LTD, 1327 W. WASHINGTON BLVD., SUITE 5G/H, CHICAGO, IL, 60607, US

(73) Assignee: Industry Development Centre, Callaghan (AU)

(21) Appl. No.: 11/995,073

(22) PCT Filed: Jul. 8, 2005
(86) PCT No.: PCT/AU2005/001009

§ 371 Date: Jan. 8, 2008

(30) Foreign Application Priority Data
Jul. 9, 2004 (AU) 2004903795

(51) Int. Cl. B32B 3/26; C08J 9/00

(52) U.S. Cl. 428/313.7; 521/79

(57) ABSTRACT

A method of forming a syntactic foam, said method including the steps of:

providing a predetermined amount of constituent materials, said constituent materials including hollow microspheres, a solvent and a first binder;

mixing the constituent materials;

allowing the constituent materials to separate into at least a phase substantially including said hollow microspheres and a binder phase;

transferring the hollow microsphere phase into a mould; and

forming a syntactic foam in said mould.

### TECHNICAL FIELD

This invention relates to a method of forming syntactic foams and novel foams made using this method. It has been developed particularly for the manufacture of syntactic foams comprised of hollow microspheres and a binder.

### BACKGROUND ART

Any discussion of the prior art throughout the specification should in no way be considered as an admission that such prior art is widely known or forms part of common general knowledge in the field.

Known syntactic foams are composite materials comprising a matrix of pre-formed hollow microspheres and a resin binder material. They are characterized by their high mechanical strength and low density. Generally, syntactic foams are used as high-performance, low density packing materials. They are typically used in undersea/marine equipment for deep-ocean current-metering, anti-submarine warfare, sandwich composites, and packing materials in the aerospace and automotive industries.

Various methods of forming syntactic foams have been developed. In any method of forming a syntactic foam, it is critically important to ensure that the hollow microspheres are not subjected to vigorous mixing, which can damage the hollow microspheres and have an adverse effect on the properties of the resulting syntactic foam. It is also important to control the amount of binder material relative to the amount of hollow microspheres so that the hollow microspheres are coated with an appropriate amount of binder. A convenient way to achieve this is under dilute mixing conditions. However, dilute conditions generally require a complex mould design having a means of draining excess solvent from the mould.

Australian patent application no. 51857/01 describes a method of manufacturing syntactic foams in a mould including the steps of combining a polymer, hollow microspheres and a solvent to form a slurry, removing a portion of the slurry through a porous wick and applying conditions which substantially solidify the polymer.

Another important consideration is the cost of presently available syntactic foams. Typically, the hollow microspheres employed are gas filled spheres made of soda-lime-borosilicate glass. The high cost of these glass hollow microspheres, together with the high cost of resin binders (such as epoxy resins) means that presently available syntactic foams are only economically viable in situations where the high-performance properties of syntactic foams justify their cost.

It would be desirable to develop a new process for forming syntactic foams which avoids damage to hollow microspheres, allows adequate control of mixing conditions and which is adaptable to the manufacture of a range of syntactic foam materials. It would also be desirable to develop a new process for forming syntactic foams which allows simple mould design. It would also be desirable to develop a low-cost syntactic foam, which may be used in a variety of industrial applications (e.g. as a building material), where the high cost of presently available syntactic foams cannot be justified.

### SUMMARY OF THE INVENTION

Accordingly, one aspect of the present invention provides a method of forming a syntactic foam, said method including the steps of:

providing a predetermined amount of constituent materials, said constituent materials including hollow microspheres, a solvent and a first binder;

mixing the constituent materials;

allowing the constituent materials to separate into at least a phase substantially including said hollow microspheres and binder and a binder phase;

transferring the hollow microspheres into a mould; and

forming a syntactic foam in said mould.

Another aspect of the present invention provides an apparatus for forming a syntactic foam, said apparatus including:

a mixer for mixing a predetermined amount of constituent materials, said constituent materials including hollow microspheres, a solvent and a first binder;

a separator in communication with said mixer for separating said constituent materials into at least a phase substantially including said hollow microspheres and a binder phase;

a mould for forming said syntactic foam; and

means for transferring the hollow microsphere phase into said mould.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

Preferably, said transferring step includes extruding or forcing said hollow microsphere phase into said mould.

Preferably, said separating step is performed in a vessel. Preferably, said hollow microsphere phase is forced or extruded into said mould by feeding a liquid into said vessel after said separating step. Preferably, the mixing step is also performed in said vessel.

Preferably, said transferring means includes a conduit fluidly connecting said separator to said mould.

Preferably, said conduit is located at an upper part of said separator.

Preferably, a liquid supply is provided for feeding said liquid into said separator to extrude or force said hollow microsphere phase through said conduit. Preferably, said liquid includes said first binder and said solvent.

Preferably, said separator includes an outlet for draining the remaining constituent material from said separator. Preferably, said outlet is located at a lower part of said separator.

Preferably, the apparatus includes a reservoir for receiving said remaining constituent material.

Preferably, the apparatus includes a conduit fluidly connected to said outlet or said reservoir for returning said remaining constituent material to said mixer.

Preferably, said mixer and said separator are the same.

Preferably, the mould is adapted for draining any excess solvent or first binder.

The method of the present invention may be used with any type of binder material and any type of hollow microsphere. However, it has been developed particularly for forming syntactic foams from cenospheres. Cenospheres are inexpensive, hollow, ceramic microspheres that are a by-product of coal-fired power stations. They are available from several sources, such as Envirospheres®, and have been used as a partial substitute for cement in cementitious compositions.

Preferably, the hollow microspheres are buoyant to facilitate the separation step.

Preferably the hollow microspheres are cenospheres.

The solvent used in the present invention may be water or an organic solvent, such as acetone. The choice of solvent will depend on the type of binder used. If the first binder is an organic resin binder (such as amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins or polyurethane resins), then the solvent will typically be an organic solvent, such as acetone. However, if the first binder is an inorganic binder, such as cement, or a natural starch-based organic binder, such as wheat flour or potato starch, then the solvent will typically be water.

In one preferred embodiment of the present invention, the first binder is an inorganic binder. Inorganic hydraulic binders are well known in the art and include calcium-based compositions, such as cements, calcium oxide and gypsum. The preferred inorganic binder used in the present invention is Portland cement. In this preferred embodiment, the hollow microsphere phase includes cenospheres and an amount of binder sufficient to coat the cenospheres. The cenosphere phase is transferred to a mould and allowed to set into a pre-form syntactic foam. Preferably, the pre-form is then subjected to post-wetting in the mould. The post-wetting step improves the mechanical strength of the cement/cenosphere pre-form syntactic foam.

Preferably, post-wetting comprises adding a second binder to the pre-form. Preferably, the second binder is an organic binder selected from amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins and polyurethane resins. Epoxy resins, phenolic resins and PVA are particularly preferred second binders in the present invention. Other binding materials, such as hardeners, may also be included with the second binder.

In the syntactic foam-forming step, the second binder is preferably diluted in an organic solvent, such as acetone, and the solution is drawn through the pre-form. This may be achieved by, for example, spraying binder solution over the mould, pouring binder solution over the mould or dipping the mould in binder solution.

Preferably, the mould allows drainage of excess binder and/or solvent from the mould. Drainage of excess binder and/or water is advantageous when fast solidification is desired. The mould may have a porous base or be a bottom-open mould having a porous material, such as a bleeding cloth or paper, underneath the mould.

The syntactic foam-forming step of the present invention may comprise a solidification step, such as a curing and/or a drying step, depending on the type of binder and solvent materials. The solidification step solidifies the binder materials into a syntactic foam. Solidification may comprise heating if the process speed is to be increased.

Preferably, the mixing step is performed in a mixer and the constituent materials are transferred to a separator for the separating step. The mixer is generally a vessel equipped with a mechanical stirrer, such as a paddle stirrer or agitator, which receives the hollow microspheres and a premixed water/binder composition. Other constituent materials (e.g. fillers, plasticisers etc.) may also be added to the mixer at this stage. The mixture may be then transferred to a separator, where the constituent materials separate into at least a phase substantially including the hollow microspheres, and a binder phase. It should be readily understood by one skilled in the art that the phase substantially including the hollow microspheres also includes an amount of binder sufficient to coat the microspheres, and will be hereinafter referred to as “the hollow microsphere phase”.

Preferably the constituent materials separate into the hollow microsphere phase, a solvent phase, and the binder phase. However, the mixing step may be carried out in the separator, if desired. The various phases may separate by settlement in the separator. Generally, the binder forms a sediment at the bottom of the separator and the buoyant hollow microspheres rise to the top of the separator, with the solvent (e.g. water) forming a phase in between the two. Mixing of the constituent materials before separation ensures that hollow microspheres are coated with at least some of the first binder material. The amount of first binder material that coats the hollow microspheres can be controlled by the initial mixing conditions.

The transfer of the hollow microsphere phase to the mould may be by any convenient means. For example, the hollow microsphere phase may be transferred by simple scooping into the mould. Preferably, the separator is specifically adapted to transfer the hollow microsphere phase to the mould by an extrusion or “squeezing” method. In this embodiment, the separator has an inlet and a conduit located at an upper part of the separator. The hollow microsphere phase may be extruded or forced (“squeezed”) from the separator via the conduit by introducing liquid into the inlet. The conduit has an outlet for discharging the hollow microsphere phase into the mould. Generally, the introduced liquid is a premixed binder/water composition.

In one embodiment, the separator includes an outlet which allows the remaining constituents to be drained from the separator once the hollow microsphere phase has been “squeezed” from the conduit outlet. The separator outlet may be located at the lower part of the separator. The remaining constituents may then be recycled back to the mixer for further mixing with a new batch of hollow microspheres. In this way, the method and apparatus of a preferred embodiment of the present invention is efficient and cost-effective.

In a further aspect, the present invention provides a syntactic foam obtainable by the method described hereinabove.

In a further aspect, the present invention provides a syntactic foam including hollow microspheres, an inorganic binder and an organic binder. Preferably, the syntactic foam includes cenospheres, cement and a resinous organic binder.

In a further aspect, the present invention provides a syntactic foam including hollow microspheres and a starch-based binder. Preferably, the syntactic foam includes cenospheres and a potato starch or a wheat flour binder.

### BRIEF DESCRIPTION OF THE DRAWINGS

A preferred embodiment of the invention will now be described, by way of example only, with reference to the accompanying drawings in which:

FIG. 1 is a schematic diagram of an apparatus according to the preferred embodiment of the present invention;

FIG. 2 is a schematic diagram illustrating the separation of the constituent materials into a hollow microsphere phase, a water phase and a cement phase;

FIG. 3 is a perspective view of a bottom-open mould used in the preferred embodiment;

FIG. 4 is a cross-sectional view of the separator; and

FIGS. 5(a)-(d) show the various stages in the transferral of the hollow microsphere phase into the mould from the separator.

### DETAILED DESCRIPTION OF THE INVENTION

### Syntactic Foam Formed By Post-Wetting a Preform

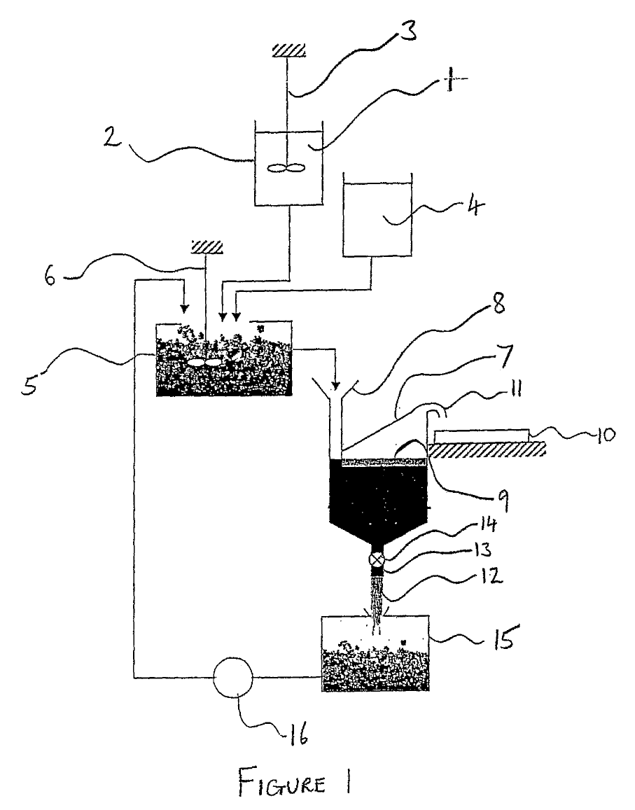

Referring to FIG. 1, a Portland cement and water composition 1 are premixed in premixer 2, by means of a mechanical stirrer 3. The composition 2 is admixed with cenospheres 4 in a mixer 5. These constituent materials are mixed together using a mechanical stirrer 6. The constituent materials in the mixer 5 are shown in Table 1.

TABLE 1

| Materials | Parts by weight |
|---|---|
| Cement (Blue Circle, Mix n' Fix - Rapid set cement) | 53 |
| Cenospheres (Bayswater power station) | 13 |
| Water | 33 |

After mixing, the constituent materials are transferred to a separator 7 via funnel inlet 8. The constituent materials settle into three phases—a wet cenosphere phase 9 (that is, a phase made of cenospheres coated with cement), a water phase 19 and a cement phase 20. The cenospheres, being buoyant in the cement and solvent mixture, rise to the upper part of the separator 7 to form the wet cenopshere phase 9. The cement phase 20 forms a sediment towards the lower part of the separator 7 with the water phase 19 in between the two phases. The upper wet cenosphere phase 9 is transferred to a mould by conduit 11 at the upper part of the separator 7. The open end of the conduit 11 forms an outlet to discharge the wet cenosphere phase 9 into the mould 10. . Excess cement/water 12 is drained from the separator by an outlet 13 at the lower part of the separator, the outlet 13 having a tap 14. The excess cement/water 12 drains into a recycling reservoir 15, where it is pumped back to the mixer 5 via pump 16.

The mould 10 is shown in more detail in FIG. 3. The mould 10 takes the form of a bottom-open mould having a porous paper base 17.

The separation step is shown in more detail in FIGS. 2 and 4. FIGS. 2 and 4 show how the constituent materials separate into the wet cenosphere phase 9, the water phase 19 and the cement phase 20.

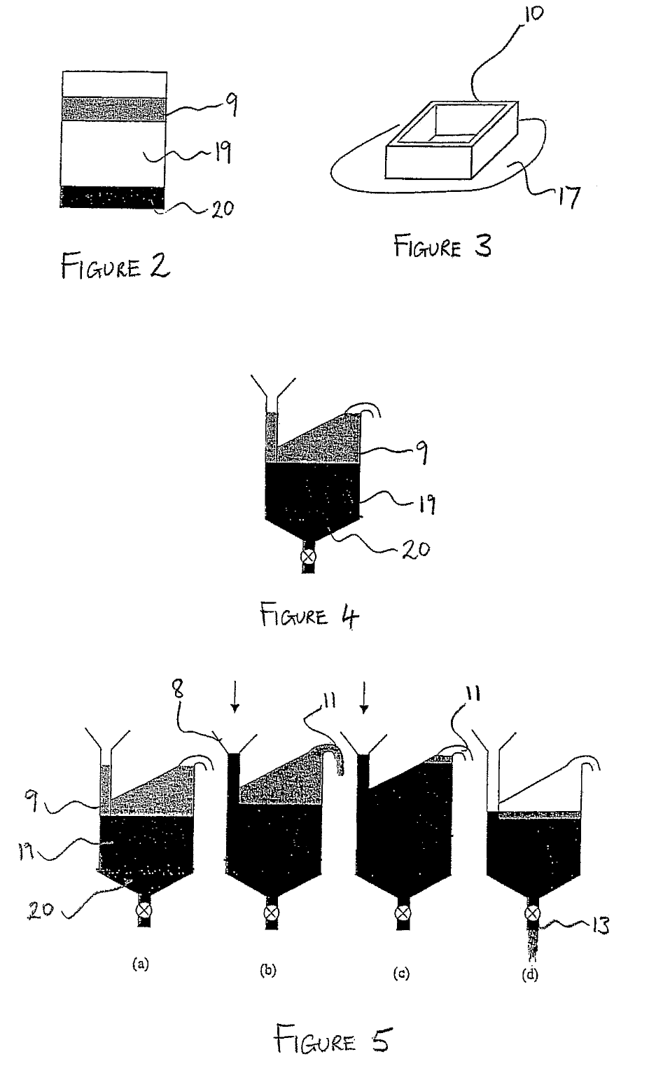

The squeezing and draining steps are shown in more detail in FIG. 5. In FIG. 5(a), phase separation is shown in which the cement sediment 20 is at the bottom of the separator, the wet cenosphere phase 9 is at the top of the separator and the water phase 19 is in the middle. In FIG. 5(b), a mixture of water and cement is fed into the inlet funnel 8, which extrudes or forces (“squeezes”) the wet cenosphere phase 9 through the conduit 11 for moulding. In FIG. 5(c), most of the wet cenosphere phase 9 has been transferred for moulding. In FIG. 5(d), the remaining constituent materials (the water phase 19 and the cement phase 20) are drained from the separator via second outlet 13 for remixing.

Returning now to the syntactic foam-forming step, the wet cenosphere phase 9 is allowed to set in the mould 10 for two days to form a pre-form syntactic foam. Excess water and cement drains through the porous paper base 17 as the pre-form syntactic foam sets. After two days, the pre-form was subjected to post-wetting. The constituent materials in the post-wetting solution are shown in Table 2.

TABLE 2

| Materials | Parts by weight |
|---|---|
| Epoxy and hardener (West System, Epoxy 105 and Slow | 11 |
| Hardener 206 - mixture ratio 5:1 volume) | |
| Acetone | 89 |

The post-wetting solution was poured onto the moulded syntactic foam and excess solvent drained through the porous paper base 17. Following post-wetting, there was provided a syntactic foam which is lightweight, durable and has high-mechanical strength. Furthermore, due to the use of inexpensive cenospheres and limited amounts of resin binder and acetone, the syntactic foam was inexpensive to produce.

### Syntactic Foam Formed Without Post-Wetting

The above procedure was followed, but without the post-wetting step. In the following examples, the diluted binders were potato starch (Tung Chun Soy & Canning Company, Hong Kong), wheat flour (Home Brand, Plain Flour) and PVA (Selleys Aquadhere Polyaliphatic Cross-Linking PVA). The constituent materials mixed together in the mixer 5 are shown in Table 3.

TABLE 3

| | Materials | | | | |
|---|---|---|---|---|---|
| | | | Wheat | Potato | |
| | Water | PVA | flour | starch | Microspheres used |
| Mass | 50 | | 1 | | Cenosphere |
| ratios | 80 | | | 1 | Cenosphere |
| | 150 | | | 1 | SLG Envirosphere ® |
| | 20 | 1 | | | SLG Envirosphere ® |
| | 20 | 1 | | | SLG Envirosphere ® |
| | 30-100 | | | 1 | SL500 Envirosphere ® |

In the case of the three examples employing wheat flour or potato starch, gelatinization (by heating for 10 minutes in water) was conducted before the binders were mixed with the hollow microspheres. The gelatinization can be conducted after moulding as part of the drying process.

These examples demonstrate the versatility of the method of the preferred embodiment of the present invention, especially in providing a method which can be used to give syntactic foams from inexpensive materials.

It will of course be appreciated that the present invention has been demonstrated by way of example only and that modifications of details may be made within the scope of invention.

1-55. (canceled)

56. A method of forming a syntactic foam, said method including the steps of:
providing a predetermined amount of constituent materials, said constituent materials including hollow microspheres, a solvent and a first binder;
mixing the constituent materials;
allowing the constituent materials to separate into at least a phase substantially including said hollow microspheres and a binder phase;
transferring the hollow microsphere phase into a mould; and
forming a syntactic foam in said mould.

57. The method of claim 56, wherein said transferring step includes extruding or forcing said hollow microsphere phase into said mould.

58. The method of claim 56, wherein said separating step is performed in a vessel.

59. The method of claim 58, wherein said hollow microsphere phase is forced or extruded into said mould by feeding a liquid into said vessel after said separating step.

60. The method of claim 58, wherein the mixing step is also performed in said vessel.

61. The method of claim 56, wherein said vessel is a separator and the mixing step is performed in a mixer, and the constituent materials are transferred to a separator for performing the separating step.

62. The method of claim 56, including the step of draining any excess solvent or first binder from said mould.

63. The method of claim 56, wherein the syntactic foam-forming step includes post-wetting of a pre-form formed in said mould.

64. The method of claim 63, wherein said post-wetting includes adding a second binder to said pre-form.

65. The method of claim 63, wherein the second binder is added by drawing a solution of the second binder through the pre-form.

66. The method of claim 56, wherein the syntactic foam-forming step includes a solidification step.

67. The method of claim 66, wherein said solidification step includes heating.

68. The method of claim 56, wherein after said transferring step the remaining constituent materials are returned to said mixing step.

69. The method of claim 56, wherein the hollow micropsheres are buoyant to facilitate said separating step.

70. The method of claim 56, wherein the hollow microspheres are cenospheres.

71. The method of claim 56, wherein the solvent is water or an organic solvent.

72. The method of claim 56, wherein the first binder is an organic binder.

73. The method of claim 72, wherein said first binder is a starch-based binder.

74. The method of claim 73, wherein said method includes the step of gelatinising said starch-based binder.

75. The method of claim 74, wherein said gelatinising step is performed prior to said mixing step.

76. The method of claim 74, wherein said gelatinising step is performed after said foam-forming step.

77. The method of claim 73, wherein the starch-based binder is wheat flour or potato starch.

78. The method of claim 56, wherein the first binder is an inorganic binder.

79. The method of claim 78, wherein the solvent is water and the first inorganic binder is a cement.

80. The method of claim 64, wherein said second binder is an organic binder.

81. The method of claim 80, wherein said organic binder is selected from amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins, polyurethane resins, wheat flour and potato starch.

82. The method of claim 72, wherein said organic binder is selected from amino resins, PVA, epoxy resins, phenolic resins, tar acid resins, urea resins, melamine resins, vinyl resins, styrene resins, acrylic resins, polyethylene resins, polycarbonate resins, acetal resins, fluorohydrocarbon resins, polyester resins, polyurethane resins, wheat flour and potato starch.

83. The method of claim 65, wherein said solution is an acetone solution.

84. An apparatus for forming a syntactic foam, said apparatus including:
a mixer for mixing a predetermined amount of constituent materials, said constituent materials including hollow microspheres, a solvent and a first binder;
a separator in communication with said mixer for separating said constituent materials into at least a phase substantially including said hollow microspheres and a binder phase;
a mould for forming said syntactic foam; and
means for transferring the hollow microsphere phase into said mould.

85. The apparatus of claim 84, wherein said transferring means includes a conduit fluidly connecting said separator to said mould.

86. The apparatus of claim 85, wherein said conduit is located at an upper part of said separator.

87. The apparatus of claim 85, wherein a liquid supply is provided for feeding said liquid into said separator to extrude or force said hollow microsphere phase through said conduit.

88. The apparatus of claim 87, wherein said liquid includes said first binder and said solvent.

89. The apparatus of claim 84, wherein said separator includes an outlet for draining the remaining constituent material from said separator.

90. The apparatus of claim 89, wherein said outlet is located at a lower part of said separator.

91. The separator of claim 89, including a reservoir for receiving said remaining constituent material.

92. The apparatus of claim 89, further comprising a conduit fluidly connected to said outlet for returning said remaining constituent material to said mixer.

93. The apparatus of claim 91, further comprising a conduit fluidly connected to said outlet or said reservoir for returning said remaining constituent material to said mixer.

94. The apparatus of claim 84, wherein said mixer and said separator are the same.

95. The apparatus of claim 84, wherein the mould is adapted for draining any excess solvent or first binder.

96. The apparatus of claim 96, wherein said mould includes a porous base.

97. The apparatus of claim 97, wherein said mould is a bottom-open mould having a base formed from bleeding cloth or paper.

98. A syntactic foam produced according to the process of claim 56.

99. A syntactic foam produced according to a process utilizing the apparatus of claim

100. A syntactic foam, including hollow microspheres, a solvent and a starch-based binder.

101. The syntactic foam of claim 100, wherein said hollow microspheres are buoyant in said solvent.

102. The syntactic foam of claim 100, wherein said hollow microspheres are cenospheres.

103. The syntactic foam of claim 100, wherein said starch-based binder is gelatinised.

104. The syntactic foam of claim 100, wherein said starch-based binder is wheat flour or potato starch.

105. The syntactic foam of claim 100, wherein said solvent is water or an organic solvent.

106. The syntactic foam of claim 105, wherein said solvent is water and wherein the ratio of water to starch is between 150:1 and 30:1.

107. The syntactic foam of claim 106, wherein the starch-based binder is wheat flour and the ratio of water to wheat flour is 50:1.

108. The syntactic foam of claim 106, wherein the starch-based binder is potato starch and the ratio of water to potato starch is 100:1.

109. The syntactic foam of claim 108, wherein the water to potato starch ratio is 80:1.

110. The syntactic foam of claim 108, wherein the water to potato starch ratio is 30:1.
